(19) United States
(12) Patent Application Publication
(10) Pub. No.: US 2009/0007204 A1
(43) Pub. Date: Jan. 1, 2009

(54) METHOD AND SYSTEM FOR PROVIDING BROADCASTING VIDEO PROGRAM

(75) Inventors: Jui-Hsiang Yang, Taipei (TW); Jiun-Kuei Jung, Taipei (TW); Hung-Shen Su, Taipei (TW); Chiao-Yung Chang, Taipei (TW); Tung-Lung Wu, Taipei (TW); Yi-Qiang Hu, Taipei (TW)

Correspondence Address: KIRTON AND MCCONKIE, 60 EAST SOUTH TEMPLE,, SUITE 1800, SALT LAKE CITY, UT, 84111, US

(73) Assignee: AVERMEDIA TECHNOLOGIES, INC., Taipei (TW)

(21) Appl. No.: 11/845,637

(22) Filed: Aug. 27, 2007

(30) Foreign Application Priority Data
Jun. 26, 2007 (TW) 096123120

(51) Int. Cl. H04N 7/173

(52) U.S. Cl. 725/110

(57) ABSTRACT

A method and a system for proving a broadcasting video program with the internet are provided. The broadcasting video program provision system includes a first data server, a second data server and a portal site. By the first data server, first broadcasting video program signals broadcast in a first area are received and converted into first stream data. By the second data server, second broadcasting video program signals broadcast in a second area are received and converted into second stream data, wherein the first area and the second area are covered by different broadcasting services. In response to an instruction issued from the user's host through the internet, the portal site transmits the first stream data or the second stream data to the user's host through the internet.

### FIELD OF THE INVENTION

The present invention relates to a method and a system for proving a broadcasting video program, and more particularly to a method and a system for proving a broadcasting video program on the internet.

### BACKGROUND OF THE INVENTION

With increasing development of digital electronic devices such as personal computers, personal digital assistants (PDAs), smart phones and the like, the functions integrated therein become more and more powerful. Recently, TV tuner cards or TV boxes are increasingly used with these digital electronic devices so that the user can watch cable/wireless/digital/analog TV programs through these digital electronic devices.

FIG. 1 is a schematic diagram illustrating a conventional TV program broadcasting system. The TV program broadcasting system principally includes a TV 10, a digital electronic device 11 cooperatively operated with a TV tuner card or a TV box, and a local TV station 19. The TV program signals transmitted from the local TV station 19 are received by the TV 10 or the digital electronic device 11 through an antenna 12 or a cable 13. With this TV program broadcasting system of FIG. 1, only localized cable/wireless/digital/analog TV programs can be received. In other words, the cable/wireless/digital/analog TV programs in other areas of the world fail to be received by the TV 10 or the digital electronic device 11.

In views of the above-described disadvantages resulted from the prior art, the applicant keeps on carving unflaggingly to develop a method and a system for proving a broadcasting video program on the internet according to the present invention through wholehearted experience and research.

### SUMMARY OF THE INVENTION

The present invention provides a method and a system for proving a broadcasting video program on the internet so that the users can watch worldwide cable/wireless/digital/analog TV programs through a personal computer or other portable electronic devices.

In accordance with a first aspect of the present invention, a method of broadcasting video program for use on the internet is provided. The method includes the following steps. The first broadcasting video program signals broadcast in a first area are received and converted into first stream data. The second broadcasting video program signals broadcast in a second area are received and converted into second stream data, wherein the first area and the second area are covered by different broadcasting services. Then, the first stream data or the second stream data are transmitted to a user's host through the internet in response to an instruction issued from the user's host to a portal site through the internet.

In an embodiment, the first and second broadcasting video program signals are converted into the first and second stream data by steps of receiving a plurality of program signals from a plurality of channels, and converting the program signals into a plurality of corresponding stream files.

In an embodiment, one of the stream files is selected and transmitted to the user's host in response to the instruction issued from the user's host to the portal site through the internet.

In an embodiment, the method further includes steps of re-encoding a relatively larger-sized TV broadcasting program stream file to generate a smaller-sized network video stream file suitable for transport on the internet, retrieving program segments of the network video stream file in a picture form or a video form at a fixed time interval to allow the user to preview the program segments, and issuing the instruction when a preview frame on the portal site is selected, so that the network video stream file corresponding to the preview frame is transmitted to the user's host through the internet in response to the instruction.

In an embodiment, the method further includes a step of recording the personalized viewing history of the user.

In an embodiment, the method further includes a step of subjecting to digital rights management and payment, wherein the first stream data or the second stream data are accessible to the user's host to be viewed or downloaded if the digital rights management and payment requirement for access of the stream data is satisfied.

In accordance with a second aspect of the present invention, a broadcasting video program provision system for use with the internet is provided. The broadcasting video program provision system includes a first data server, a second data server and a portal site. The first data server receives first broadcasting video program signals broadcast in a first area and converts the first broadcasting video program signals into first stream data. The second data server receives second broadcasting video program signals broadcast in a second area and converts the second broadcasting video program signals into second stream data. The first area and the second area are covered by different broadcasting services. The portal site receives an instruction from a user's host through the internet, so that the first stream data or the second stream data are transmitted to the user's host through the internet.

In an embodiment, each of the first and second data servers includes a multi-channel receiving unit, a media access stream data server, a network video stream data server and an integrated service controller. The multi-channel receiving unit receives a plurality of program signals from a plurality of channels. The media access stream data server is communicated with the multi-channel receiving unit, and converts the program signals into corresponding stream files. The network video stream data server is communicated with the portal site and the media access stream data server for re-encoding a relatively larger-sized TV broadcasting program stream file provided by the multi-channel receiving unit, thereby generating a smaller-sized network video stream file suitable for transport on the internet. The integrated service controller is communicated with the portal site and the media access stream data server for retrieving program segments of the network video stream file in a picture form or a video form at a fixed time interval to allow the user to preview the program segments, receiving and processing the user's operation of the portal site, and requesting to access and use a selected stream file.

In an embodiment, the multi-channel receiving unit includes at least one digital program signal receiver, which includes a tuner and a demodulator.

In an embodiment, the multi-channel receiving unit includes at least one analog program signal receiver, which includes a tuner, a decoder and an encoder.

In an embodiment, the personalized viewing history is recorded by the integrated service controller.

In an embodiment, one of the stream files is selected and transmitted to the user's host in response to the instruction issued from the user's host to the portal site through the internet.

In an embodiment, the portal site has a plurality of preview frames corresponding to the stream files to be previewed by the user through the internet. The instruction is issued by clicking one of the preview frames. The network video stream file corresponding to the preview frame is transmitted to the user's host through the internet in response to the instruction.

In an embodiment, each of the first and second data servers further includes a digital rights management and payment system for controlling access of the first and second stream data. The stream data are accessible to the user's host to be viewed or downloaded if the digital rights management and payment requirement for access of the stream data is satisfied.

In accordance with a third aspect of the present invention, another method of providing a broadcasting video program for use on the internet is provided. The broadcasting video program provision method includes the following steps. The first broadcasting video program signals broadcast in a first area are received and converted into first stream data. The second broadcasting video program signals broadcast in a second area are received and converted into second stream data, wherein the first area and the second area are covered by different broadcasting services. Then, the first data or the second data are saved as a file in response to a recording instruction issued from the user's host to a portal site through the internet.

In an embodiment, the first and second broadcasting video program signals are converted into the first and second stream data by steps of receiving a plurality of program signals from a plurality of channels, and converting the program signals into corresponding stream files.

In an embodiment, a specified stream file corresponding to the recording instruction is selected from the stream files and saved as a video file if the recording instruction issued from the user's host through the internet is a scheduled recording instruction.

In an embodiment, the video file is transmitted to the user's host through the internet in response to a request issued from the user host.

In an embodiment, a message is transmitted from the portal site to a user host or a user-exclusive RSS reader through the internet after the video file has been saved.

In an embodiment, the method further includes steps of re-encoding a relatively larger-sized TV broadcasting program stream file to generate a smaller-sized network video stream file suitable for transmission on the internet, retrieving program segments of the network video stream file in a picture form or a video form at a fixed time interval to allow the user to preview the program segments, and issuing the instruction when a preview frame on the portal site is selected, so that the network video stream file corresponding to the preview frame is saved as a video file in response to the instruction.

In an embodiment, the method further includes a step of recording the personalized viewing history.

In accordance with a fourth aspect of the present invention, another broadcasting video program provision system for use with the internet is provided. The broadcasting video program provision system includes a first data server, a second data server and a portal site. The first data server receives first broadcasting video program signals broadcast in a first area and converts the first broadcasting video program signals into a first data. The second data server receives second broadcasting video program signals broadcast in a second area and converts the second broadcasting video signals into second data. The first area and the second area are covered by different broadcasting services. The portal site may save the first data or the second data as a file in response to a recording instruction issued from the user's host to the portal site through the internet.

In an embodiment, each of the first and second data servers includes a multi-channel receiving unit, a media access stream data server, a download service processing unit and an integrated service controller. The multi-channel receiving unit receives a plurality of program signals from channels. The media access stream data server is communicated with the multi-channel receiving unit, and converts the program signals into corresponding stream files. The download service processing unit is communicated with the media access stream data server and the portal site for processing and saving one of the stream files as a video file. The video file is downloaded into the user's host through the portal site when the user's host is connected to the portal site. The integrated service controller is communicated with the portal site and the media access stream data server for retrieving program segments of the network video stream file in a picture form or a video-form at a fixed time interval to allow the user to preview the program segments, receiving and processing the user's operation of the portal site, and requesting to access and use the stream data files.

In an embodiment, the integrated service controller selects a specified stream file corresponding to the recording instruction from the stream files and saves the specified stream file as a video file if the recording instruction issued from the user's host through the internet is a scheduled recording instruction.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic diagram illustrating a conventional TV program broadcasting system;

FIG. 2 is a schematic functional block diagram illustrating a broadcasting video program provision system according to a preferred embodiment of the present invention;

FIG. 3 is a schematic functional block diagram illustrating implementation of the broadcasting video program provision system of the present invention;

FIG. 4 is a schematic functional block diagram illustrating the portal site of the broadcasting video program provision system;

FIG. 5 is a schematic functional block diagram illustrating a broadcasting video program provision system according to another preferred embodiment of the present invention; and

FIGS. 6A and 6B are flowcharts illustrating a broadcasting video program provision method of the present invention.

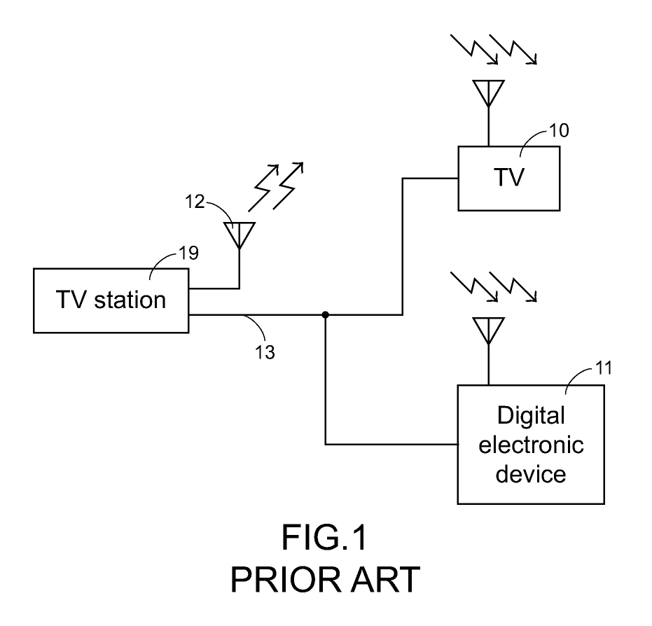

### DETAILED DESCRIPTION OF THE PREFERRED EMBODIMENT

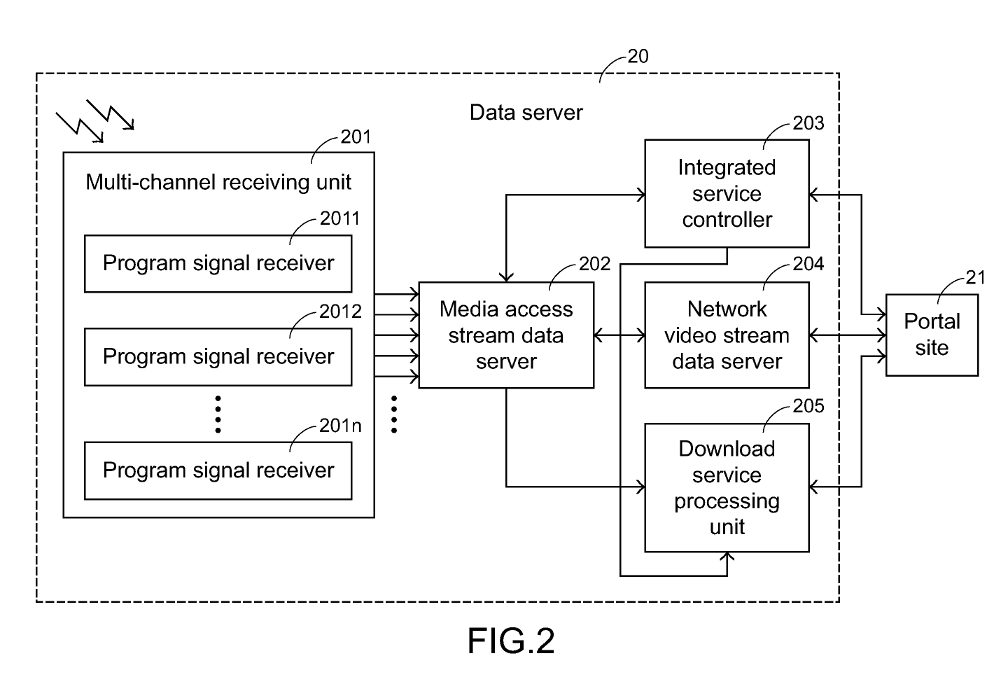

Referring to FIG. 2, a schematic functional block diagram of a broadcasting video program provision system according to a preferred embodiment of the present invention is illustrated. The system of FIG. 2 includes a plurality of data servers 20 and a portal site 21. These data servers 20 are set up in many areas covered by different broadcasting services from each other. For clarity, only one data server 20 is shown in the drawing. For example, individual data servers 20 may be set up in Taiwan, America and China mainland, but only one portal site 21 is required for allowing users anywhere in the world to login and browse the contents of various TV programs.

For each data server 20, a multi-channel receiving unit 201, a media access stream data server 202, an integrated service controller 203, a network video stream data server 204 and a download service processing unit 205 are included.

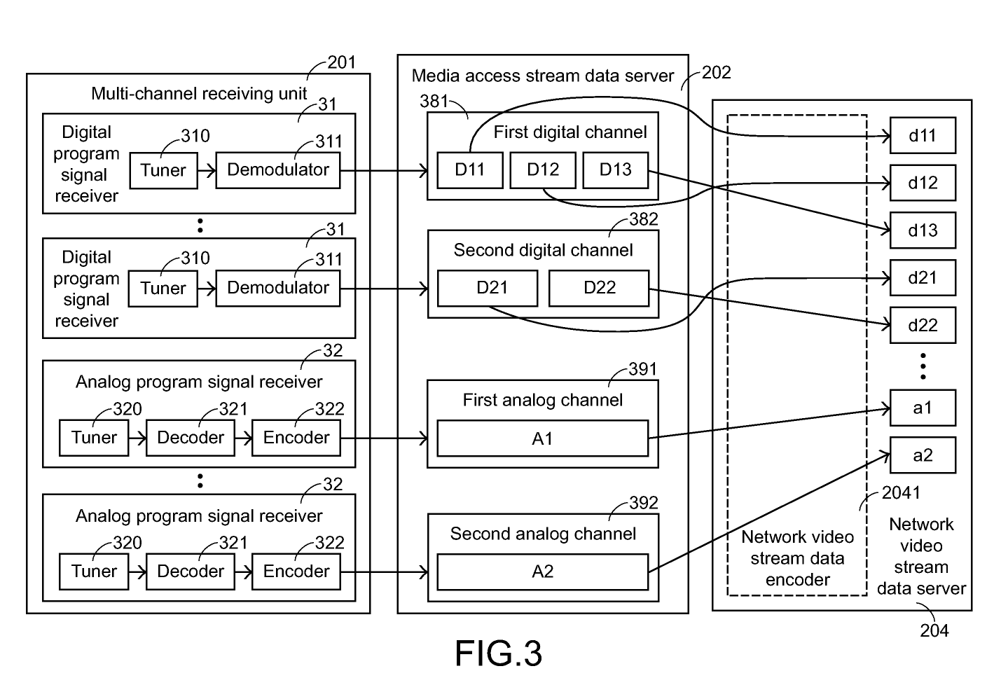

The multi-channel receiving unit 201 receives program signals from a plurality of digital/analog/cable/wireless channels. For receiving digital TV broadcasting signals and analog TV broadcasting signals, the multi-channel receiving unit 201 includes, for example, several program signal receivers 2011, 2012, . . . , 201n. An embodiment of the multi-channel receiving unit 201 may be illustrated with reference to FIG. 3. Generally, there are two types of program signal receivers, i.e. digital program signal receivers 31 and analog program signal receivers 32. The digital program signal receiver 31 principally includes a tuner 310 and a demodulator 311. The analog program signal receiver 32 principally includes a tuner 320, a decoder 321 and an encoder 322. By the way, the functions of the multi-channel receiving unit 201 may be implemented by a single machine or cooperatively done by several machines.

The program signals received and processed by the program signal receivers of the multi-channel receiving unit 201 are then transmitted to the media access stream data server 202. By associating each index value with a corresponding program from a channel, the transport stream data corresponding to the processed program signals from different program signal receivers will be stored in corresponding memory units (e.g. circular buffers) of the media access stream data server 202 without impairing the video broadcasting quality. In consequence, many TV program files in a format of transport stream data are stored in the media access stream data server 202 for selection. An embodiment of the media access stream data server 202 may also be illustrated with reference to FIG. 3. These TV program files are numbered according to the broadcasting types (digital or analog) and the channel information. For example, as shown in FIG. 3, the index values D11, D12 and D13 are associated with the first digital channel 381, the index values D21 and D22 are associated with the second digital channel 382, the index value A1 is associated with the first analog channel 391, and the index value A2 is associated with the second analog channel 392. The prefix of the index value denotes the broadcasting type of the file, for example D=digital or A=analog. For example, the index values D11, D13 and D21 denote the first segment from the first digital channel 381, the third segment from the first digital channel 381 and the first segment from the second digital channel 382, respectively. In addition, the index values A1 and A2 indicate the program of the first analog channel 391 and the program of the second analog channel 392, respectively.

The integrated service controller 203 is primarily used to perform the following three tasks. The first task includes retrieving program segments of the stream files of each channel in a picture form or a video form from the media access stream data server 202 at a fixed time interval, thereby allowing the users to preview the program segments of every channel on the portal site 21. The second task includes receiving and processing the user's operation of the portal site 21, and requesting to access and use the stream files of media access stream data server 202. The third task includes recording the personalized viewing history and proving exclusive personal services.

For facilitating the users to watch TV broadcasting programs via the network with limited bandwidth, the network video stream data server 204 may include a network video stream data encoder 2041, as is shown in FIG. 3. By means of the network video stream data encoder 2041, the relatively larger-sized TV broadcasting program stream files provided by the multi-channel receiving unit 201 will be re-encoded to generate smaller-sized network video stream files d11, d12, d13, d21, d22, a1, a2, and so on. For every broadcasting program provided by the multi-channel receiving unit 201, a corresponding network video stream file suitable for transport on the internet is generated. Consequently, the users may watch programs of every channel when the data server 20 is communicated with the portal site 21. By the way, the functions of the network video stream data server 204 may be implemented by a single machine or cooperatively done by several machines.

Moreover, the broadcasting video program provision system has extended functions of scheduled recording video files and providing video files having TV broadcasting video quality. By inputting a video recording instruction through the portal site 21, the integrated service controller 203 may retrieve a certain segment of a specified stream file from the media access stream data server 202 according to the user's recording settings. The certain segment of the specified stream file is processed by the download service processing unit 205 and saved as a video file, which will be downloaded by the user's host through the portal site 21.

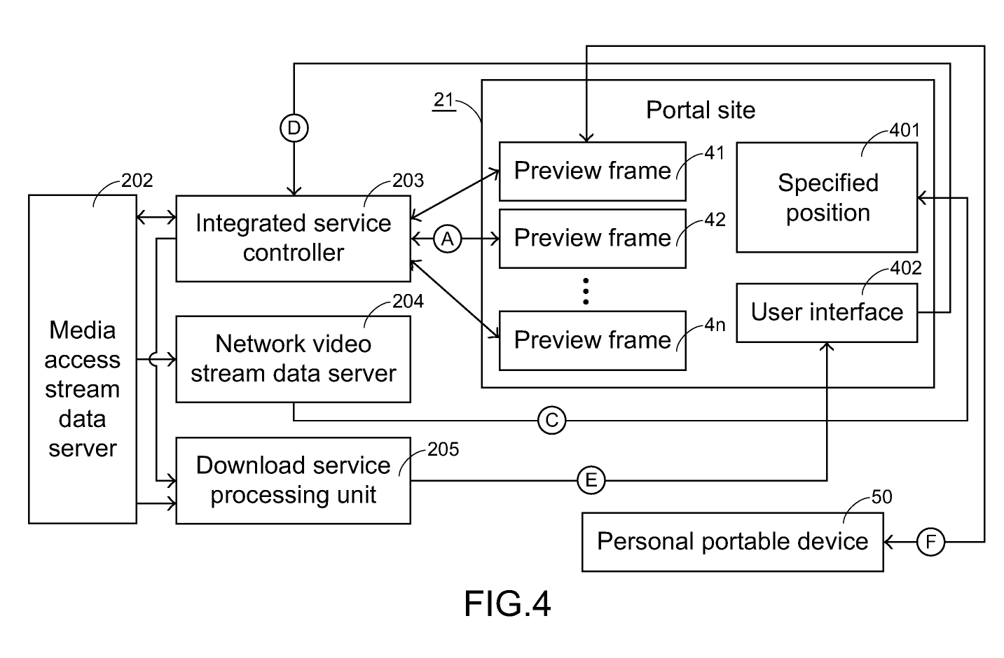

FIG. 4 is a schematic functional block diagram illustrating the portal site 21 operated with the data server. Through the integrated service controllers 203 located at different areas, the preview frames 41, 42, . . . , 4n of corresponding programs coming from different area channels are transmitted to the portal site 21 along path A and shown on the portal site 21. Under this circumstance, the users may preview various programs from different channels in real time. Furthermore, when one of the preview frames shown on the monitor of the computer system is selected, the portal site 21 will redirect information of the specified program to a corresponding integrated service controller 203 along path A. In response to reception of this information, the integrated service controller 203 will select a corresponding stream file from the media access stream data server 202. The stream file will be processed by the network video stream data server 204 into a network video stream file, e.g. one of the network video stream files d11, d12, d13, d21, d22, a1, a2 as shown in FIG. 3. The network video stream file will be transmitted to the portal site 21 through the internet and then redirected to the user's host, or directly transmitted to the user's computer through the internet. Under this circumstance, the network video stream file may be displayed on a specified position 401 of the monitor of the computer system along path C.

Furthermore, for recording a program being watched or scheduled recording video files, the portal site 21 may provide a user interface 402 for the user to input recording settings. The portal site 21 will output the recording settings including the start/end time and information for identifying the specified program to the corresponding integrated service controller 203 along path D. According to the recording settings, the integrated service controller 203 may retrieve the stream file in the corresponding media access stream data server 202. The retrieved stream file is processed by the download service processing unit 205 and saved as a video file. The video file will be downloaded through the portal site 21 along path E. Optionally, the users may communicate their personal portable devices 50 with the portal site 21 along path F and select favorite channels. In consequence, the information of the favorite channels may be received in real time through for example a really simple syndication (RSS) service. In response to an immediate recording or scheduled recording instruction inputted through the personal portable device 50, the recorded video files may be downloaded when the user's computer is available to be communicated with the portal site 21.

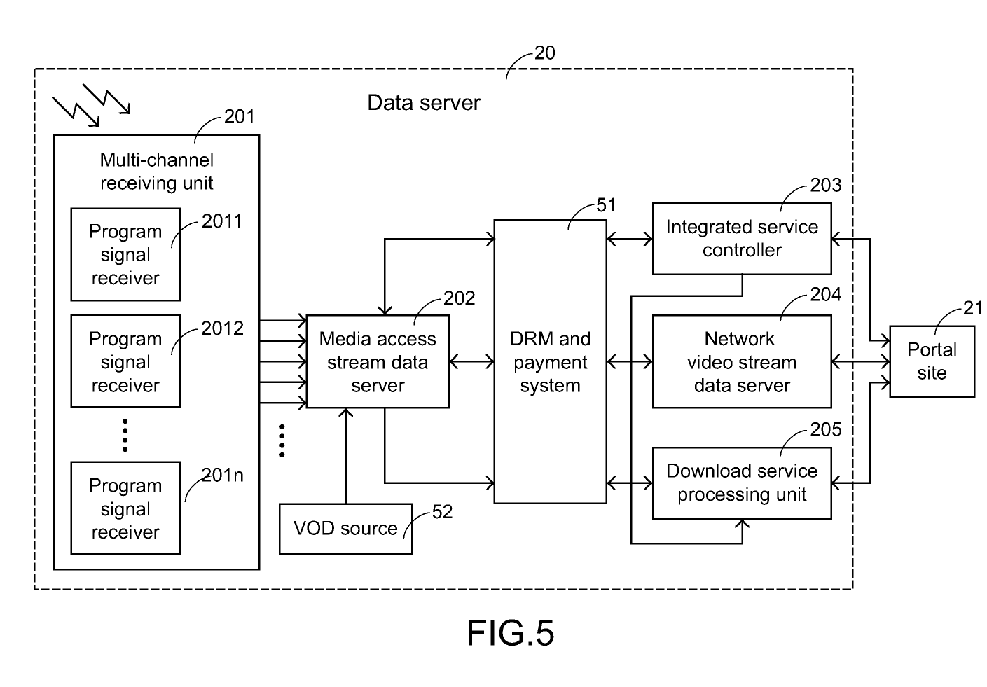

A further embodiment of a broadcasting video program provision system is illustrated in FIG. 5. In this embodiment, the portal site 21, the multi-channel receiving unit 201, the media access stream data server 202, the integrated service controller 203, the network video stream data server 204 and the download service processing unit 205 included therein are similar to those shown in FIG. 2, and are not redundantly described herein. In addition, the broadcasting video program provision system of FIG. 5 further includes a digital rights management (DRM) and payment system 51. The digital rights management and payment system 51 is interconnected between the media access stream data server 202, the integrated service controller 203, the network video stream data server 204 and the download service processing unit 205. The digital rights management and payment system 51 is responsible for controlling data access of the local pay channel or the video-on-demand (VOD) source 52. The video files are accessible by the user's host for display or download if no rights are reserved to the video files or the user has made payment to subscribe access services.

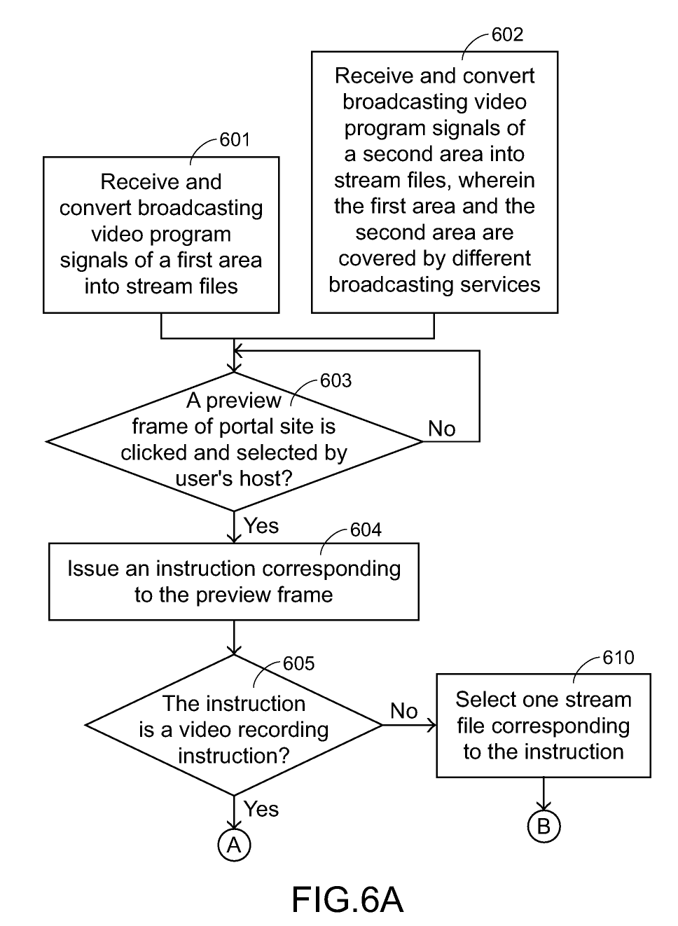

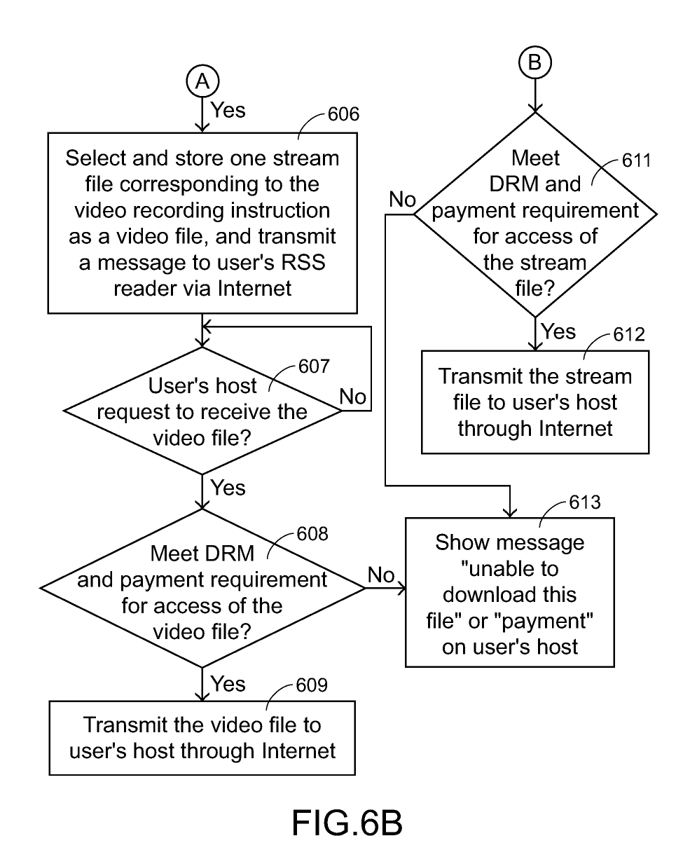

Hereinafter, a broadcasting video program provision method will be illustrated as follows with reference to the flowchart of FIGS. 6A and 6B.

First of all, a plurality of broadcasting video program signals broadcast in a first area are received and converted into a plurality of stream files (Step 601), and a plurality of broadcasting video program signals broadcast in a second area are received and converted into a plurality of stream files (Step 602). The first area and the second area are covered by different broadcasting services. If a preview frame on the portal site 21 is clicked and selected by the user's host (Step 603), an instruction corresponding to the preview frame is issued and transmitted to the portal site 21 (Step 604). If the instruction is a video recording instruction (Step 605), a video stream file corresponding to the video recording instruction is selected from the plurality of stream files and saved as a video file, and a message is transmitted to a the user's RSS reader through the internet (Step 606). Alternatively, a message is transmitted to the user's host via an e-mail. Once the user's host requests to receive the file (Step 607), a step of subjecting to digital rights management and payment is needed. If the digital rights management and payment requirement is satisfied (Step 608), the file will be successfully transmitted to the user's host through the internet (Step 609). On the other hand, if the instruction is not a video recording instruction at step 605, a video stream file corresponding to the instruction is selected from the stream files for on-line show (Step 610). If the digital rights management and payment requirement is met (Step 611), the file will be successfully transmitted to the user's host through the internet (Step 612). In the steps 611 and 608, if the user fails to fill the digital rights management and payment requirement for access of the video file, a message indicating “unable to download this file” or “payment” will be shown on the user's host.

From the above description, the users of personal computers or personal portable devices may watch cable/wireless/digital/analog TV programs from the worldwide TV stations by using the broadcasting video program provision system of the present invention. Moreover, the broadcasting video program provision system may offer additional services, e.g. downloading service. The concept of the broadcasting video program provision system may be applied to video data transmission on the internet.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method of providing a broadcasting video program for use on the internet, the method comprising steps of:
receiving first broadcasting video program signals broadcast in a first area and converting the first broadcasting video program signals into first stream data;
receiving second broadcasting video program signals broadcast in a second area and converting the second broadcasting video program signals into second stream data, wherein the first area and the second area are covered by different broadcasting services; and
transmitting the first stream data or the second stream data to a user's host through the internet in response to an instruction issued from the user's host to a portal site through the internet.

2. The method according to claim 1 wherein the first and second broadcasting video program signals are converted into the first and second stream data by steps of:
receiving a plurality of program signals from a plurality of channels, respectively; and
converting the program signals into a plurality of corresponding stream files.

3. The method according to claim 2 wherein in response to the instruction issued from the user's host to the portal site through the internet, one of the stream files is selected and transmitted to the user's host through the internet.

4. The method according to claim 3, further comprising steps of:
re-encoding a TV broadcasting program stream file, thereby generating a smaller-sized network video stream file to be transported on the internet;
retrieving program segments of the network video stream file in a picture form or a video form at a fixed time interval, thereby allowing the user to preview the program segments; and
issuing the instruction when a preview frame on the portal site is selected, so that the network video stream file corresponding to the preview frame is transmitted to the user's host through the internet in response to the instruction.

5. The method according to claim 3, further comprising a step of recording personalized viewing history of the user.

6. The method according to claim 1, further comprising a step of subjecting to digital rights management and payment, wherein the stream data are accessible to the user's host to be viewed or downloaded if the digital rights management and payment requirement for access of the stream data is satisfied.

7. A broadcasting video program provision system for use with the internet, the broadcasting video program provision system comprising:
a first data server for receiving first broadcasting video program signals broadcast in a first area and converting the first broadcasting video program signal into first stream data;
a second data server for receiving second broadcasting video program signals broadcast in a second area and converting the second broadcasting video program signals into second stream data, wherein the first area and the second area are covered by different broadcasting services; and
a portal site for transmitting the first stream data or the second stream data to a user's host through the internet in response to an instruction from the user's host through the internet.

8. The broadcasting video program provision system according to claim 7 wherein each of the first and second data servers comprises:
a multi-channel receiving unit for receiving a plurality of program signals from a plurality of channels;
a media access stream data server communicated with the multi-channel receiving unit, and converting the program signals into a plurality of corresponding stream files;
a network video stream data server communicated with the portal site and the media access stream data server for re-encoding a TV broadcasting program stream file generated by the multi-channel receiving unit, thereby generating a smaller-sized network video stream file to be transported on the internet; and
an integrated service controller communicated with the portal site and the media access stream data server for retrieving program segments of the network video stream file in a picture form or a video form at a fixed time interval to allow the user to preview the program segments, receiving and processing the user's operation of the portal site, and requesting to access and use a selected stream file.

9. The broadcasting video program provision system according to claim 8 wherein the multi-channel receiving unit comprises:
at least one digital program signal receiver having a tuner and a demodulator; and
at least one analog program signal receiver having a tuner, a decoder and an encoder.

10. The broadcasting video program provision system according to claim 8 wherein the integrated service controller records the personalized viewing history of the user.

11. The broadcasting video program provision system according to claim 7 wherein in response to the instruction issued from the user's host to the portal site through the internet, one of the stream files is selected and transmitted to the user's host.

12. The broadcasting video program provision system according to claim 7 wherein the portal site has a plurality of preview frames corresponding to the stream files to be previewed by the user through the user's host, and in response to the instruction issued by clicking one of the preview frames, one stream file corresponding to the preview frame is transmitted to the user's host through the internet.

13. The broadcasting video program provision system according to claim 7 wherein each of the first and second data servers further comprises a digital rights management and payment system for controlling access of the stream data, wherein the stream data are accessible to the user's host to be viewed or downloaded if the digital rights management and payment requirement for access of the stream data is satisfied.

14. A method of providing a broadcasting video program for use on the internet, the method comprising steps of:
receiving first broadcasting video program signals broadcast in a first area and converting the first broadcasting video program signals into first data;
receiving second broadcasting video program signals broadcast in a second area and converting the second broadcasting video program signals into second data, wherein the first area and the second area covered by different broadcasting services; and
saving the first data or the second data as a file in response to a recording instruction issued from the user's host to a portal site through the internet.

15. The method according to claim 14 wherein the broadcasting video program signals are converted into the data by steps of:
receiving a plurality of program signals from a plurality of channels; and
converting the program signals into a plurality of stream files.

16. The method according to claim 15 further comprising steps of:
re-encoding a TV broadcasting program stream file, thereby generating a smaller-sized network video stream file to be transported on the internet;
retrieving program segments of the network video stream file in a picture form or a video form at a fixed time interval, thereby allowing the user to preview the program segments; and
issuing the instruction when a preview frame on the portal site is selected, so that the network video stream file corresponding to the preview frame is saved as a video file in response to the instruction.

17. A broadcasting video program provision system for use with the internet, the broadcasting video program provision system comprising:
a first data server for receiving first broadcasting video program signals broadcast in a first area and converting the first broadcasting video program signals into first data;
a second data server for receiving second broadcasting video program signals broadcast in a second area and converting the second broadcasting video program signals into second data, wherein the first area and the second area are covered by different broadcasting services; and
a portal site for saving the first data or the second data as a file in response to a recording instruction issued from the user's host through the internet.

18. The broadcasting video program provision system according to claim 17 wherein each of the first and second data servers comprises:
a multi-channel receiving unit for receiving a plurality of program signals from a plurality of channels;
a media access stream data server communicated with the multi-channel receiving unit, and converting the program signals into a plurality of corresponding stream files;
a download service processing unit communicated with the media access stream data server and the portal site for processing and saving one of the stream files as a video file to be downloaded into the user's host connected to the portal site;
an integrated service controller communicated with the portal site and the media access stream data server for retrieving program segments of the network video stream file in a picture form or a video form at a fixed time interval to allow the user to preview the program segments, receiving and processing the user's operation of the portal site, and requesting to access and use the stream files; and
a digital rights management and payment system for controlling access of the stream data, wherein the stream data are accessible to the user's host to be viewed or downloaded if the digital rights and payment requirement is satisfied

19. The broadcasting video program provision system according to claim 18 wherein the integrated service controller selects a specified stream file corresponding to the recording instruction from the stream files and saves the specified stream file as a video file if the recording instruction issued from the user's host through the internet is a scheduled recording instruction.

20. The broadcasting video program provision system according to claim 19 wherein the portal site transmits the video file to the user's host through the internet in response to a request issued from the user's host.

21. The broadcasting video program provision system according to claim 19 wherein the portal site transmits a message to the user's host or a user's RSS reader through the internet after the video file is completely saved.
